(19) United States
(12) Patent Application Publication
(10) Pub. No.: US 2009/0070720 A1
(43) Pub. Date: Mar. 12, 2009

(54) System to Identify Timing Differences from Logic Block Changes and Associated Methods

(75) Inventors: Reinaldo A. Bergamaschi, Tarrytown, NY (US); Sean M. Carey, Hyde Park, NY (US); Brian W. Curran, Saugerties, NY (US); Prabhakar N. Kudva, New York, NY (US); Lawrence Lange, Wappingers Falls, NY (US); Matthew E. Mariani, York Haven, PA (US); Mark D. Mayo, Wappingers Falls, NY (US); Ruchir Puri, Baldwin Place, NY (US); Gebhard Weber, Baden Wortemberg (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/853,276

(22) Filed: Sep. 11, 2007

(51) Int. Cl. G06F 17/50

(52) U.S. Cl. 716/6

(57) ABSTRACT

A system to identify timing differences due to logic block changes, the system may include a controller, and storage in communication with the controller. The controller may provide delay values of a previous logic block and a current logic block. The system may also include a timing-modeler to compare the delay values of the previous logic block with the current logic block for timing analysis. The system may further include an interface that provides a report based upon the previous logic block and the current logic block comparison.

### RELATED APPLICATION

This application contains subject matter related to the subject matter of a co-pending application entitled “Logic Block Timing Estimation Using Conesize” and having an attorney docket number of POU920070032US1, the entire subject matter of which is incorporated herein by reference in its entirety. The aforementioned application is assigned to the same assignee as this application, International Business Machines Corporation of Armonk, N.Y.

### FIELD OF THE INVENTION

The invention relates generally to the field of microprocessor design, and particularly to the areas of frequency and static timing analysis.

### BACKGROUND OF THE INVENTION

It is generally understood that as transistor device size continues to decrease, device speeds in processors have continued to increase. With the assumption of higher device speeds, the traditional processor design approach has been focused on defining the logical architecture, or pipeline, and the physical partitioning of the processor, with little up-front consideration of the ability to meet frequency requirements. However, as current process technologies, including 65 nm and 45 nm, are beginning to reach theoretical limits of both device and interconnect speed, frequency analysis, or timing analysis, should now be considered during the high-level design stage in order to verify a given processor pipeline design might function within the given cycle time constraints.

To perform this analysis, a segment of logic/VHDL (VHSIC Hardware Description Language) could be converted into a quantifiable unit of time, or delay, that can be summed and measured against the target cycle time. One such proposed method is conesize-based delay approximation found in the co-pending application entitled “Logic Block Timing Estimation Using Conesize” and having an attorney docket number of POU920070032US1, which uses empirical data to estimate the delay of a logic block given the number of logical inputs (i.e. the conesize). This method may be useful for immediate delay estimation; however, the result may be a snapshot of the logic delay at a given point in time.

In a real implementation, the logical design of a pipeline architecture usually changes significantly through the high-level design phase. Therefore, a logic block that meets timing requirements at a given point in the design cycle may fail as logic is added or changed, which frequently occurs during the design stage.

For instance, in traditional processor design cycles a given logic block iteration is delivered by a logic designer and given to another party for timing analysis. That block is converted to an individualized timing rule, and the rule is inserted into a global timing model. This translation and subsequent usage of the data could require days or longer before the timing impact of logic change can be measured. In addition, it becomes difficult to pinpoint the low level logic blocks that have changed from the global timing model.

### SUMMARY OF THE INVENTION

Advantages in accordance with various embodiments of the invention are provided by a system to identify timing differences due to logic block changes. The system may include a controller, and storage in communication with the controller. The controller may provide delay values of a previous logic block and a current logic block. The system may also include a timing-modeler to compare the delay values of the previous logic block with the current logic block for timing analysis.

The system may further include an interface that provides a report based upon the previous logic block and the current logic block comparison. The interface may enable report filtering.

The interface may also provide selectable values to be used when the previous logic block and the current logic block are compared. The interface selectable values may be user-defined, may include overrides for known timing situations, and thresholds for reporting timing differences.

The controller may generate the delay values of the previous logic block with the current logic block using conesize-based approximations. The conesize-based approximations may be based upon empirically derived data. The controller may use logic synthesis files to generate the delay values.

Another aspect of the invention is a method to identify timing differences due to logic block changes. The method may include generating delay values of a previous logic block and a current logic block, and comparing the delay values of the previous logic block with the current logic block for timing analysis.

The method may further include providing a report based upon the previous logic block and the current logic block comparison. The method may also include filtering the report using overrides for known timing situations and thresholds for reporting timing differences.

### BRIEF DESCRIPTION OF THE DRAWINGS

FIG. 1 is a block diagram illustrating a system to identify timing differences due to logic block changes in accordance with one embodiment of the invention.

FIG. 2 is illustrates a generic VHDL cone of logic, showing the syntax for delay statements used in the process for high level design timing analysis in accordance with one embodiment of the invention.

FIG. 3 shows an example of an exception case for conesize timing estimation, where a critical path may be a better indicator of the overall delay, and the process syntax used to identify this situation in accordance with one embodiment of the invention.

FIG. 4 shows an example of an exception case for conesize timing estimation, where the conesize may not be a true indicator of the circuit delay (a decoder structure), and the process syntax used to identify this situation in accordance with one embodiment of the invention.

FIG. 5 shows an example of an exception case for conesize timing estimation, where a critical path is a better indicator of the overall delay (a select signal in a MUX structure), and the process syntax used to identify this situation in accordance with one embodiment of the invention.

FIG. 6 illustrates an example of a high-level view of the process for high level design timing analysis, expanded to show specific stages of the internal application and input mechanisms for specifying user-defined delay overrides in accordance with one embodiment of the invention.

FIG. 7 is a flowchart illustrating a method of identifying timing differences due to logic block changes in accordance with the invention of FIG. 1.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

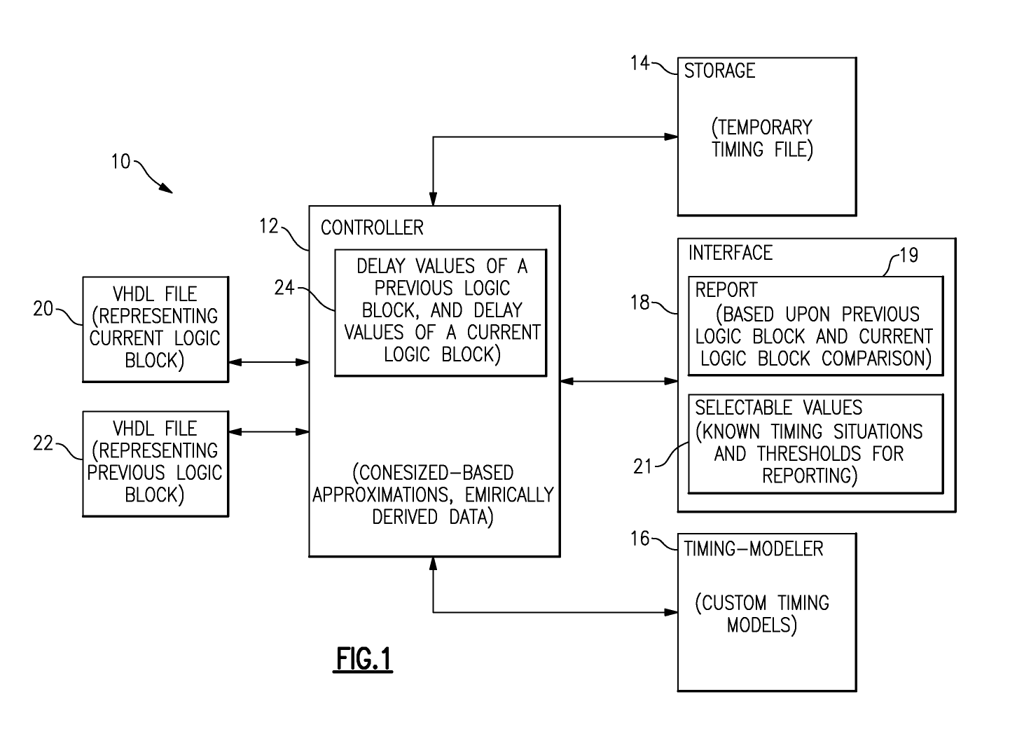

Referring initially to FIG. 1, a system 10 to identify timing differences due to logic block changes is initially described. The system includes a controller 12, such as a microprocessor, processor, or other logic circuitry. In one embodiment, the controller 12 provides delay values 24 of a previous logic block and a current logic block.

In another embodiment, the controller 12 generates the delay values 24 of the previous logic block with the current logic block using conesize-based approximations. The conesize-based approximations may be based upon empirically derived data. In addition, the controller 12 uses logic synthesis files to generate the delay values 24, such as VHDL, Verilog, or the like.

The controller 12 is in communication with storage 14 as will be appreciated by those of skill in the art. In other embodiments, the storage 14 may be embedded in the controller 12.

In another embodiment, the system 10 further includes a timing-modeler 16 that compares the delay values 24 of the previous logic block with the current logic block for timing analysis. In yet another embodiment, the system 10 includes an interface 18 that permits the system 10 to communicate with a user and/or other users as will be appreciated by those of skill in the art. The interface 18 provides a report 19 based upon the previous logic block and the current logic block comparison, for example. The report 19 may be a computer file or the like by which a user or users may access the output of system 10.

In one embodiment, the interface 18 enables filtering of the report 19. For instance, the interface 18 provides selectable values 21 that may be used when the previous logic block and the current logic block are compared such as overrides for known timing situations, thresholds used for reporting timing differences, and the like. In addition, the selectable values 21 may be user-defined.

Accordingly, system 10 provides a solution for analyzing changes in the delay characteristics of logic blocks, using a hardware-based equation for calculating delay as a function of VHDL conesize, for example. By including the ability to include user-defined overrides and report filtering, designers can more easily track the stability of the logic and ensure timing closure during the microprocessor high-level design phase.

For example, in traditional processor design cycles, a given logic block iteration is delivered by a logic designer and given to another party for timing analysis. That block is converted to an individualized timing rule, and the rule is inserted into a global timing model. This translation and subsequent usage of the data could require days or longer before the timing impact of logic change can be measured. Additionally, it becomes difficult to pinpoint the low level logic blocks that have changed from the global timing model.

To address such, system 10 provides a process that provides a fast response to timing impact due to logic modification. In other words, system 10 has the ability to illustrate the relative effect on delay due to the logic change and may be executable near when a logic update is received, in order to provide rapid designer feedback. This process could be used to generate necessary timing feedback in order to influence pipeline architecture decisions and changes during high level design phases, ultimately, helping to provide a frequency-feasible design point.

Because this frequency analysis was not used in previous process technologies, no solutions have been developed. Mental estimation and conesize-based approximation methods have been used to estimate timing impact due to singular logic changes.

An exemplary operation of one embodiment of the system 10 which addresses this problem is now described. The controller 12 uses a VHDL file 20 of a current logic block and a VHDL file 22 of a previous logic block as inputs, and the controller translates both files in parallel into delay values (estimation models) 24 using conesize-based approximation. In another embodiment, the controller 12 performs the preceding process in series, and other logic synthesis modeling languages such as Verilog, ABEL (Advanced Boolean Equation Language), or the like may be used.

The timing-modeler 16 compares the delay values 24, and performs timing analysis. The interface 18 provides a report 19 based upon such a comparison.

In the first step of this example, the controller 12 parses the respective VHDL files using conesize-based estimation in order to generate the delay values 24 approximations. These delay values 24 are expressed in a temporary timing file.

The timing-modeler 16 generates custom timing models based upon the temporary timing file. In one embodiment the custom timing models are formatted for the EinsTimer modeling environment. The timing-modeler 16 uses the custom timing models to determine the timing behavior of each model, and calculates differences between the two.

The interface 18 produces timing details for all inputs to a report 19 file based upon the timing behavior of each model, and the calculated differences between the two. In one embodiment, the interface 18 shows the timing deltas only.

In another embodiment, a user may have a need or desire to manually override the estimated delay value 24 results of the conesize-based approximation to overcome certain VHDL/logic structures. In order to allow this, VHDL text-based constructs may be added to the process that could be embedded within the source VHDL files as comment lines. These constructs could then be detected by a vhdl-to-.tfile translator in order to affect the specified override.

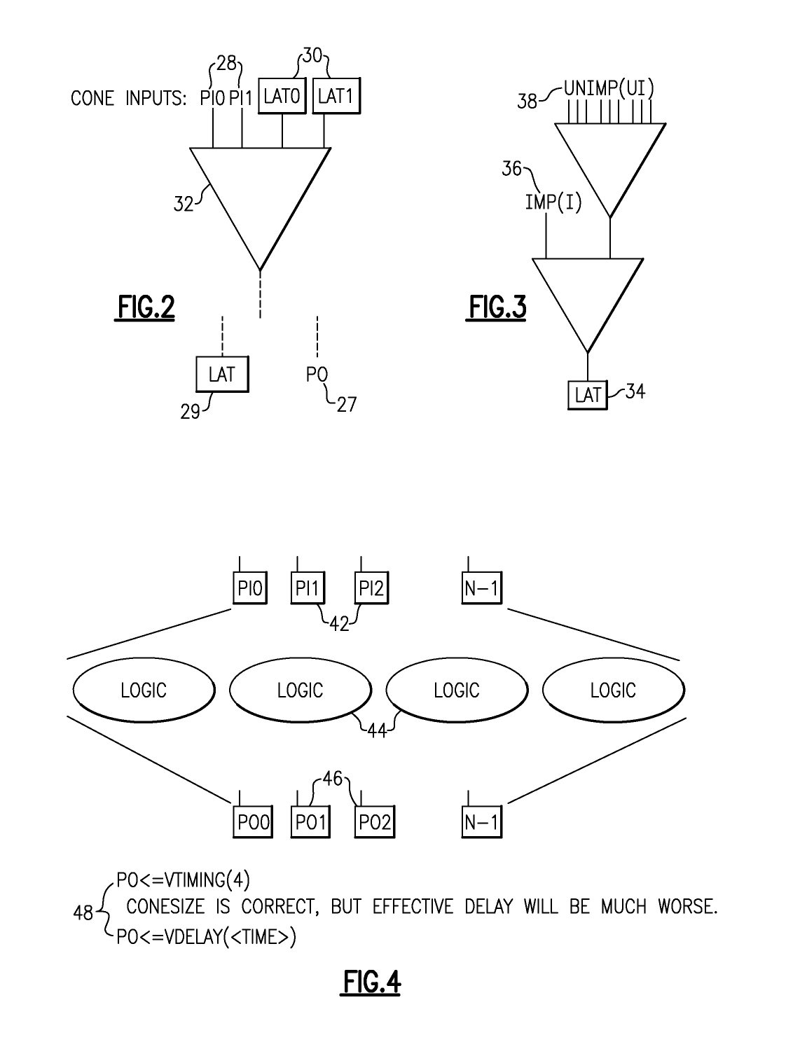

To provide further explanation, FIG. 2 provides an illustration of a basic conesize-based VHDL timing statement (i.e. “vtiming”). Examples of vtiming are as follows: vlat=vtiming(PI0,PI1A, . . . , # Laches); vlat=vtiming(PI0,PI1A,2); or PO<=vtiming (PI0,PI1A,2). In FIG. 2, a Lat, such as Lat 29, is a VHDL latch that provides a generic state-holding circuit, for example. In addition, a PO, like PO 27, is a primary output such as a logical signal that leaves a given block of logic, and that is used to drive inputs to other sets of logic, for instance. Similarly, a PI, like PI 28 is a primary input such as a logical signal that enters a given block of logic, and that is used to drive logic circuits and/or latches within that block of logic, for example.

As defined previously, the delay value 24 of a particular logic block is a function of the number of inputs, for instance. Therefore, vtiming statements reflect the specific primary VHDL inputs (PIs 28) and latch bounded inputs 30 from internal state machines.

A raw vtiming statement only considers the quantity of inputs to the logic block; it does not consider the importance of the signals involved. Therefore, the first type of delay override construct, “vtoverride”, covers the scenario in which a signal entering the cone “late,” or downstream, in the logic sequence is the dominant factor of the overall delay of the cone (and where other inputs to the cone are known to be relatively unimportant).

This is shown in an example as FIG. 3. Using the vtoverride construct 34, the user can specify the important inputs 36 into a cone to be used for the timing delay estimation. Examples of vtoverride are as follows: vlat,=vtiming(I,UI0, UI1, . . . ); vlat,=vtov(I, 1); vlat,=vtov(UI0, 7); or vlat,=vtov(UI1, 7). Presumably, the specified conesize is less than the default size comprised of all potential inputs. This statement is most useful when the VHDL designer has a good understanding of the physical implementation of the relevant logic.

Additional cases may be found where the logic designer needed to apply a raw timing delay override to the value generated by conesize-based approximation. The construct used in this case, ‘vdelay’, allows the user to “hardcode” a delay amount in units of time rather than conesize.

Referring to FIG. 4, an example situation is where a logic cone has a minimal amount of inputs 42 to the cone; however, the subsequent logic involved 44 is characterized by a large fanout before the result PO's 46 are determined. The large fanout leads to a higher actual delay than would be estimated by conesize-based approximation. Decoder structures are good examples. Use of the ‘vdelay’ construct may require the logic designer to be aware of the VHDL structure being implemented and is therefore most effective when the designer applies some amount of analysis in order to derive the timing delay value 48 used in the override.

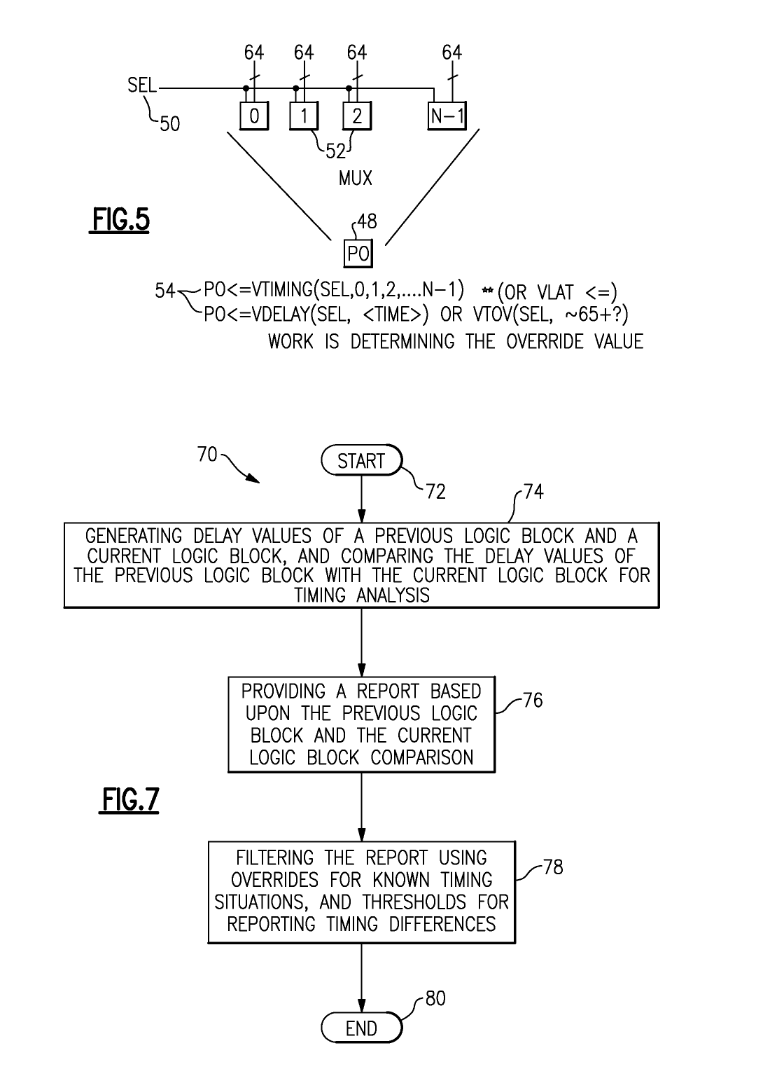

Other examples of logic structures were found where either ‘vtoverride’ or ‘vdelay’ could be used. One such case is MUX structures, as shown in FIG. 5, where the actual circuit delay is a function of an important select signal 50 rather than the wide data inputs or conesize 52 (an example might be a 64-bit bus selection). ‘vtoverride’ could be used to express the importance of the select signal 50; however, because the behavior of the logic structure is well known, a raw delay (i.e. ‘vdelay’) could also be used 54.

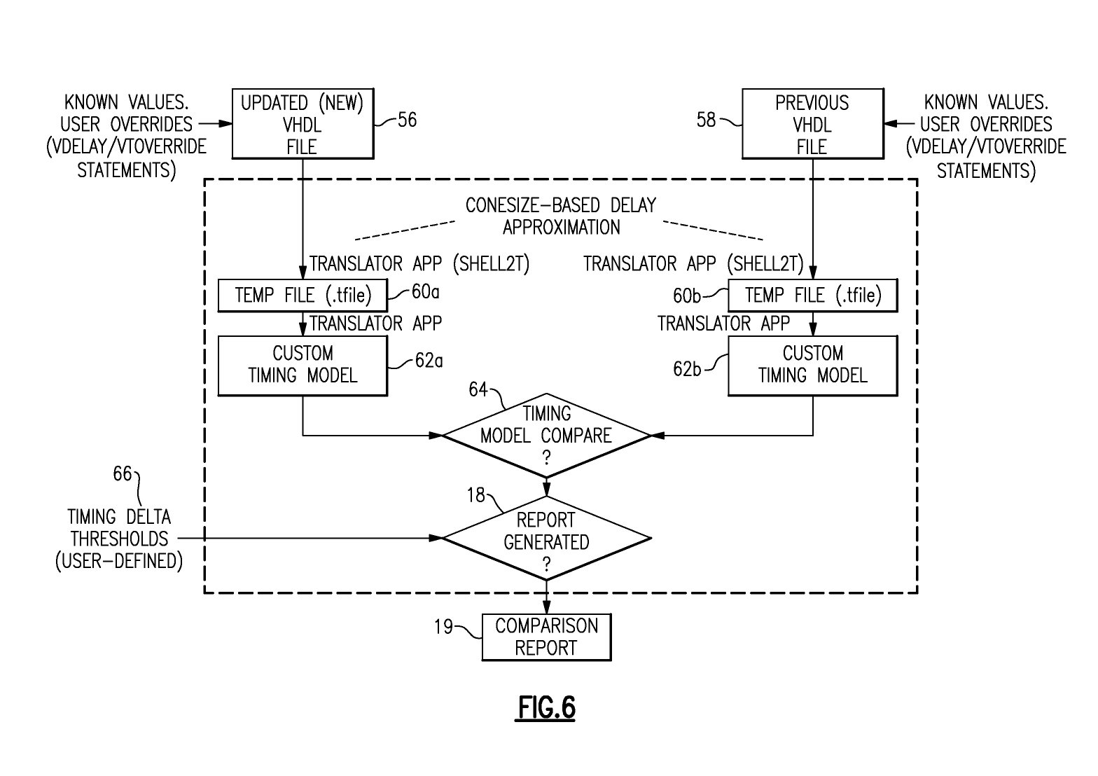

The majority of the discussion to this point addresses the timing analysis and handling of the input VHDL data; however, the analysis of the output timing data leads to an additional set of challenges for the high-level timing analysis process. FIG. 6 shows one embodiment of such a process and is used for the following paragraphs.

After all vtiming and override statements in the two source VHDL files 56 and 58 are converted into delay values/models 60a and 60b, the process executes additional applications that compare timing results and determine deltas 62a, 62b, and 64. When this process is applied to large quantities of VHDL input files, which is very typical of custom microprocessor designs, there can be very large quantities of deltas on each pass of analysis. This creates the need for timing delta filtering.

In the high-level design phase, timing analysis is usually concerned with large variations in timing signals that might affect the architecture of the processor being designed. Therefore, the process was further enhanced to allow delay delta thresholds 66 to be passed into the interface 18 used to generator the report 19. In other words, the user could choose the magnitude of delay delta that would trigger an alert by the process, thereby reducing the quantity of timing data that needs analysis, and more quickly highlighting major timing changes in the VHDL architecture. Note also that as the delay delta threshold is reduced, more VHDL changes may be identified.

The quantity of deltas per VHDL file can also be useful for indicating the relative stability of the logic block in question (or lack there of). Logic stability is a key indicator of the readiness of the design to enter the implementation phase. A logic block with many timing deltas over time may indicate the logic is not read for implementation.

Experience has shown that ‘vtoverride’ (specification of important inputs) and ‘vdelay’ (delay override) provided additional flexibility to the process of using conesize-based approximation for early timing feedback. The work involved is used to determine either an important signal or a delay override value; however, the additional time spent yields a more accurate timing model and more rapid closure of high-level design timing analysis.

Accordingly, the system 10 provides a progressive comparison of the logic block design over time. The capabilities of system 10 may be implemented in software, firmware, hardware or some combination thereof.

Another aspect of the invention is a method to identify timing differences due to logic block changes, which is now described with reference to flowchart 70 of FIG. 7. The method begins at Block 72 and may include generating delay values of a previous logic block and a current logic block, and comparing the delay values of the previous logic block with the current logic block for timing analysis at Block 74. The method may also include providing a report based upon the previous logic block and the current logic block comparison at Block 76. The method may further include filtering the report using overrides for known timing situations, and thresholds for reporting timing differences at Block 78. The method ends at Block 80.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A system to identify timing differences due to logic block changes, the system comprising:
a controller providing delay values of a previous logic block and a current logic block; and
a timing-modeler to compare the delay values of the previous logic block with the current logic block for timing analysis.

2. The system of claim 1 further comprising an interface that provides a report based upon the previous logic block and the current logic block comparison.

3. The system of claim 2 wherein said interface enables report filtering.

4. The system of claim 2 wherein said interface provides selectable values to be used when the previous logic block and the current logic block are compared.

5. The system of claim 4 wherein said interface selectable values are user-defined.

6. The system of claim 4 wherein said interface selectable values include overrides for known timing situations, and thresholds for reporting timing differences.

7. The system of claim 1 wherein said controller generates the delay values of the previous logic block with the current logic block using conesize-based approximations.

8. The system of claim 7 wherein said controller generates the conesize-based approximations based upon empirically derived data.

9. The system of claim 7 wherein said controller uses logic synthesis files to generate the delay values.

10. A method to identify timing differences due to logic block changes, the method comprising:
generating delay values of a previous logic block and a current logic block; and
comparing the delay values of the previous logic block with the current logic block for timing analysis.

11. The method of claim 10 further comprising providing a report based upon the previous logic block and the current logic block comparison.

12. The method of claim 11 further comprising filtering the report using overrides for known timing situations and thresholds for reporting timing differences.

13. The method of claim 12 wherein the overrides and thresholds are user-defined.

14. The method of claim 10 wherein the delay values are generated using conesize-based approximation based upon empirically derived data.

15. The method of claim 10 wherein the delay values are generated using logic synthesis files.

16. A computer program product embodied in a tangible media comprising:
computer readable program codes coupled to the tangible media for identify timing differences due to logic block changes, the computer readable program codes configured to cause the program to:
generate delay values of a previous logic block and a current logic block; and
compare the delay values of the previous logic block with the current logic block for timing analysis.

17. The computer program product of claim 16 further comprising program code configured to: provide a report based upon the previous logic block and the current logic block comparison.

18. The computer program product of claim 16 further comprising program code configured to: filter the report using overrides for known timing situations and thresholds for reporting timing differences.

19. The computer program product of claim 16 further comprising program code configured to: generate delay values using conesize-based approximation based upon empirically derived data.

20. The computer program product of claim 16 further comprising program code configured to: generate the delay values using logic synthesis files.
